(19) United States
(12) Patent Application Publication
(10) Pub. No.: US 2011/0206238 A1
(43) Pub. Date: Aug. 25, 2011

(54) PHARMACEUTICAL RECOGNITION AND IDENTIFICATION SYSTEM AND METHOD OF USE

(76) Inventor: Darin Kinser, Bedford, IN (US)

(21) Appl. No.: 13/097,919

(22) Filed: Apr. 29, 2011

(51) Int. Cl. G06K 9/00

(52) U.S. Cl. 382/103

(57) ABSTRACT

An electronic pharmaceutical recognition and identification system is provided along with a method of use. In certain example embodiments a user can take a digital picture of a pharmaceutical with a portable appliance comprising a telephone, then text that picture to a predetermined telephone number, wait a short period of time for a pharmaceutical identification server system to electronically recognize and identify the pharmaceutical in question, and then automatically receive a text message back from the server system that includes various predetermined information regarding the pharmaceutical in question, such as its name, pictures of it, warnings, whether or not a prescription is required, as well as usage and interaction information. Fixed appliances are also provided that can passively interface with a pharmaceutical dispensing system to ensure that the prescribed pharmaceutical is being dispensed.

### BACKGROUND OF THE INVENTION

1. Field of the Invention

The present invention relates to a pharmaceutical recognition and identification system and method of use.

2. Description of Related Art

Pharmacists are often asked to work long hours under grueling pressure, leading to mistakes in filling prescriptions for pharmaceuticals. Such errors can have extremely grave consequences, such as when a South Carolina pharmacist reportedly provided a mother a bottle of pills that was supposed to contain Ritalin, a medication to control her 8-year-old daughter's hyperactivity. But instead of Ritalin, the pills inside were a diabetes drug, at sixteen times the adult dosage. After taking the medication, the little girl sank into a coma and suffered permanent brain damage. All because of human error in identifying the pills.

Such mistakes are increasingly common. More than 100,000 Americans die each year of adverse drug reactions, according to a landmark report in the Journal of the American Medical Association, making such reactions one of the six leading causes of death in the United States. Many of those deaths are understood to be the result of errors in identification of drugs, both before and after they are dispensed to consumers. For example, researchers analyzed 9,846 prescriptions filled at a hospital's outpatient pharmacy in Springfield, N.J., and they reportedly found 1,371 mistakes, including many bottles containing the wrong pills. In other words, mistakes were made in roughly one in eight of the prescriptions. Unless consumers know what their pharmaceuticals should look like, they effectively have no chance to detect these potentially deadly errors.

The likelihood of such mistakes is increased by the ever-growing number of new drugs with complicated and often similar sounding names, drugs like Cerebyx, Celexa, and Celebrex, each of which is prescribed to treat very different conditions. One in every four medication errors, studies show, may be a name-confusion error. Accordingly, an improved system is needed for identifying pharmaceuticals by appearance. Also needed is a system and method that would readily allow consumers to confirm the identify of their drugs before taking them.

Another problem is abuse of pharmaceuticals, which is increasingly rampant among young people. According to a report by ABC News, there is a culture of carelessness among young people with respect to ingesting pharmaceuticals. This includes a shocking and potentially deadly practice called “pharm parties,” where teenagers are purported to place an array of pharmaceuticals into a bowl, then pass around the “trail mix” for the partygoers to “graze.” The partygoers then pick up and ingest various unidentified pharmaceuticals from the bowl without having any idea what they are taking. It would be helpful if there was a system and method that was sufficiently convenient for teenagers to use to quickly identify pharmaceuticals and information regarding them, for instance to avoid deadly interactions.

A related issue that frequently arises is identification of pharmaceuticals by law enforcement officers. Possessing prescription pharmaceuticals without a prescription is usually a crime. Police officers are frequently confronted with suspects carrying unidentified pharmaceuticals in an unmarked container, which might or might not be prescription pharmaceuticals. If the officer does not immediately recognize the pharmaceutical, she or he must usually take the pharmaceuticals back to the police station, where the officer manually flips through pages in a book in an attempt to identify the pharmaceutical. If the pharmaceutical cannot be found in the book, officers may resort to searching websites on the Internet, where they manually review pictures and compare them to the pharmaceutical. Searching the web for answers is not guaranteed to produce accurate results, however. Moreover, all these methods are extremely time consuming, inconvenient, and do not guarantee reliable identification. What is needed is a quick, reliable, portable system and method for identifying pharmaceuticals that could be used in the field by law enforcement officers.

### SUMMARY

The present invention addresses these issues and more with a novel system and method that recognizes and identifies pharmaceuticals by using an electronic camera to create electronic image data regarding the pharmaceutical in question, automatically comparing that image data to a database of image data regarding known pharmaceuticals, using one or more algorithms to identify which of the known pharmaceuticals matches the image data regarding the pharmaceutical in question, obtaining electronic information regarding the matched pharmaceutical from one or more databases, and electronically communicating that information to a user.

In various example embodiments the electronic camera may be part of a portable appliance such as a cell phone, PDA, laptop computer, electronic tablet, or any other electronic device. The system may be included partially or entirely in, and the method steps may be performed partially or entirely in, a single appliance, such as an appliance adapted to be portable, or an appliance not adapted to be portable.

In various example embodiments, portions of the system, and various method steps, may be performed remotely from the appliance. For example, the appliance may in certain example embodiments be connected wirelessly or by wire with a network, and the network may be connected with one or more computers. The appliance in such example embodiments may create one or more sets of electronic image data regarding the pharmaceutical in question using an electronic camera, and may communicate that data wirelessly or by wire through a network to one or more computers, which may process the data, compare the data to one or more databases of image data regarding known pharmaceuticals, use one or more algorithms to identify which of the known pharmaceuticals sufficiently matches the image data regarding the pharmaceutical in question, obtain electronic information regarding the matched pharmaceutical from one or more databases, and then cause that information to be electronically communicated to a user. In various example embodiments, the information may be electronically communicated from the one or more computers through a network, back to the first appliance or a different appliance, and that appliance may then display the information to the user or take other action.

In certain example embodiments, the appliance may be a user's cell phone or similar device that comprises a digital camera, and the user may create electronic image data regarding the pharmaceutical in question by taking one or more digital pictures of the pharmaceutical in question, which the user then sends as an SMS, MMS, text, email or other similar electronic message to a designated recipient phone number or address. Upon receipt of the electronic message at the designated recipient phone number or address, the message may be directed to one or more computers that process the message, extract image data regarding the pharmaceutical in question from the message, and compare that image data to one or more databases of image data regarding known pharmaceuticals, using one or more algorithms to identify which of the known pharmaceuticals matches the image data regarding the pharmaceutical in question. One or more computers then obtain electronic information regarding the matched known pharmaceutical from one or more databases, and electronically communicate that information back to a user, for instance by automatically sending an email, SMS message, MMS message, or other electronic message containing the information through a wireless network back to the user's wireless appliance, where the information is then displayed to the user. This is just one example application of the system.

In certain other example embodiments, the appliance may be adapted to be located in a fixed location in a pharmacy or pharmaceutical dispensing structure, and may be adapted to operate passively to automatically check or verify that the correct pharmaceuticals are being dispensed. For example, an appliance may be oriented to direct an electronic camera at a pharmaceutical dispensing structure, and the electronic camera may be adapted to automatically “photograph” or take digital image information regarding pharmaceuticals as they are being dispensed from or through the pharmaceutical dispensing structure. The system may process the digital information as described in other example embodiments, identify a match to a known pharmaceutical, and send information regarding the matched pharmaceutical to one or more computers that contain the identity of the pharmaceutical that is intended to be dispensed. The system could then make a comparison to ensure that the matched pharmaceutical identified by the system is indeed the same as the pharmaceutical that is intended to be dispensed. If they are not the same, an alert could be communicated to a user or a mechanism activated to prevent the pharmaceutical from being dispensed or sold to a consumer until a further investigation takes place to confirm that the consumer is receiving the intended pharmaceutical.

In various example embodiments, the information provided to the user may include any of the following or combinations thereof: one or more pictures of the matched pharmaceutical, the name of the matched pharmaceutical, the identity of the manufacturer(s), the chemicals comprising the matched pharmaceutical, whether or not a prescription is required for the matched pharmaceutical, warnings, prescribed uses, indications and contra-indications, side effects, precautions, interactions, and overdose information. These are just examples; any suitable information may be used.

Where more than one known pharmaceutical matches the data regarding the pharmaceutical in question, or where the system cannot determine with sufficient certainty which of a number of known pharmaceuticals is the match for the pharmaceutical in question, the system in various example embodiments may return to a user an error message, or may return to a user information regarding a plurality of potential matches for the user to manually compare with the pharmaceutical in question. An error message may include an instruction to re-do the process, or a request for additional data, such as an additional digital picture of one or more additional sides of the pharmaceutical in question. The system may then combine any additional provided data with previously provided data regarding the pharmaceutical in question to determine a match.

Also provided are method steps for utilizing the systems described herein.

The foregoing summary is provided to show examples of the invention and not to define or otherwise limit the scope of the invention.

### BRIEF DESCRIPTION OF THE DRAWINGS

FIG. 1 is a diagram of a first example system according to certain embodiments of the invention.

FIG. 2 is a diagram of a second example system according to certain embodiments of the invention.

FIG. 3 is a diagram of a third example system according to certain embodiments of the invention.

FIG. 4 is a flow chart showing various optional steps of an example method of utilizing an example system according to certain embodiments of the invention.

In the following description, like reference numbers from the figures may be used to refer to like elements/features in connection with various different embodiments.

### DETAILED DESCRIPTION OF EXAMPLE EMBODIMENTS

Reference will now be made in detail to some specific examples of the invention, including any best mode contemplated by the inventor for carrying out the invention. Examples of these specific embodiments are illustrated in the accompanying drawings. While the invention is described in conjunction with these specific embodiments, it will be understood that it is not intended to limit the invention to the described or illustrated embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, process operations well known to persons of skill in the art have not been described in detail in order not to obscure unnecessarily the present invention.

Various techniques and mechanisms of the present invention will sometimes be described in singular form for clarity. However, it should be noted that some embodiments include multiple iterations of a technique or multiple mechanisms unless noted otherwise. For example, a system may or may not utilize a network. However, it will be appreciated that a system can use multiple networks while remaining within the scope of the present invention unless otherwise noted. Likewise, a system may or may not utilize a plurality of databases while remaining within the scope of the present invention, unless otherwise noted. These are just examples.

Similarly, various steps of the methods shown and described herein are not necessarily performed in the order indicated, or performed at all in certain embodiments. Accordingly, some implementations of the methods discussed herein may include more or fewer steps than those shown or described.

Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. For example, several entities are described as connected by, or communicating through, various networks and systems, but it will be appreciated that a variety of computer systems, computer networks, phone lines, satellite communications, wireless networks and the like may or may not exist between and within the entities and systems shown. Consequently, an indicated connection does not necessarily mean a direct, unimpeded connection unless otherwise noted.

### Example 1

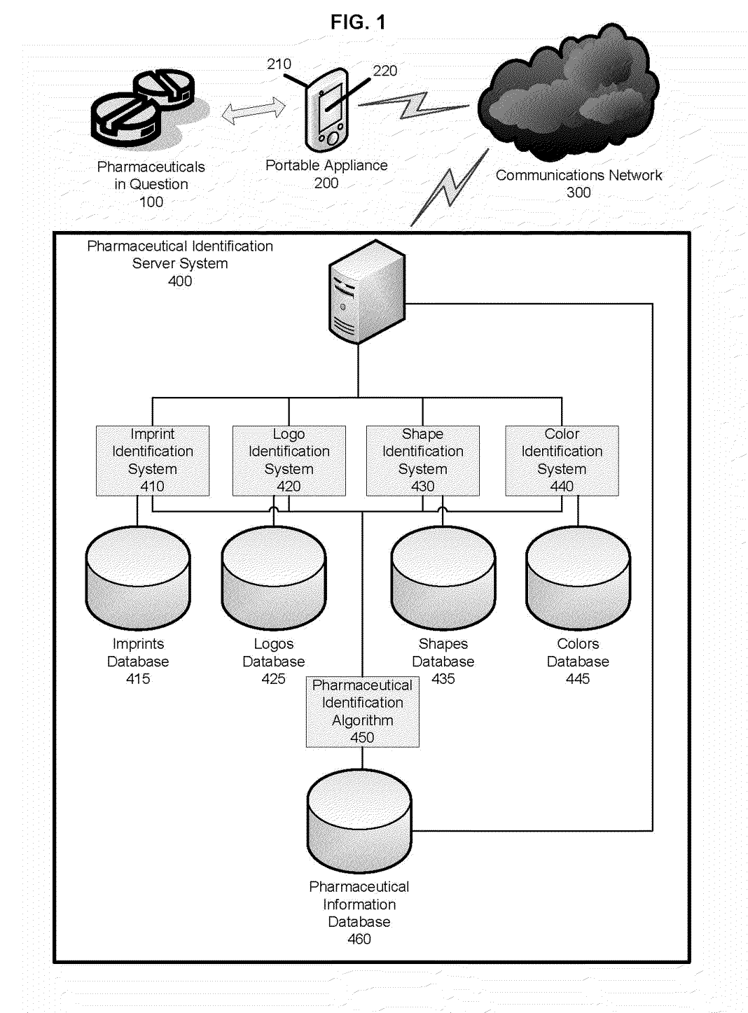

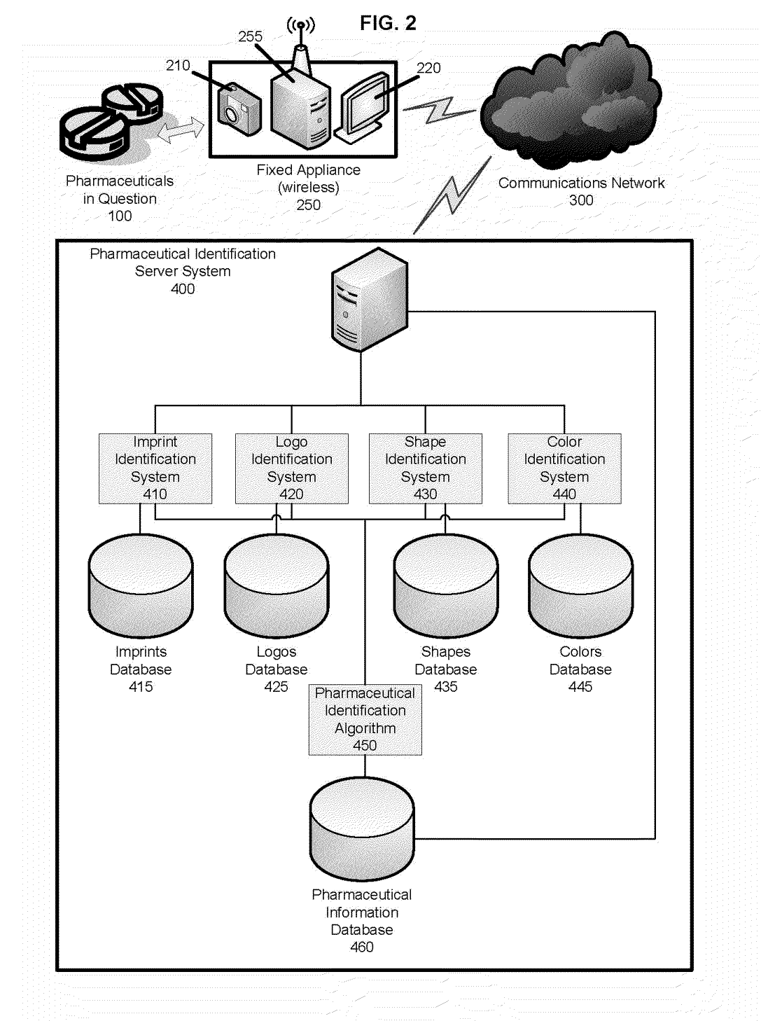

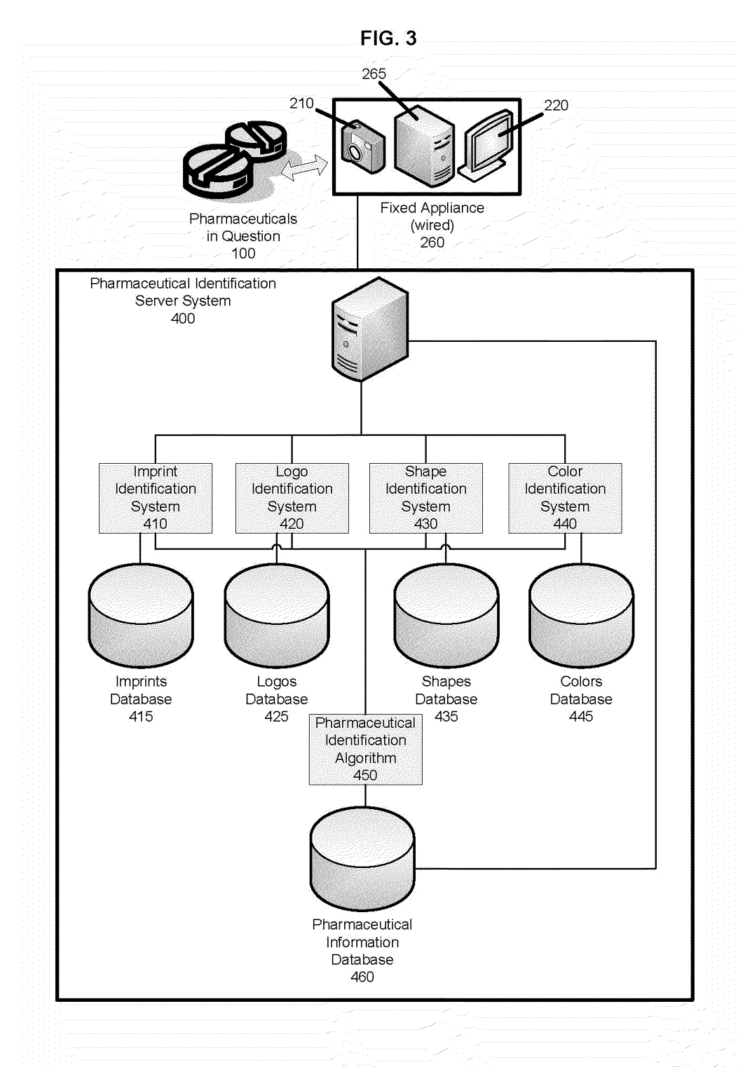

Turning now to FIG. 1, shown are certain optional elements of an example system for recognizing and identifying one or more unidentified pharmaceuticals, referred to herein as the pharmaceutical(s) in question 100. For purposes of this disclosure a pharmaceutical includes any chemical substance(s) intended for medical use that take the form of an ingestible object, such as a pill, tablet or capsule, as well as packaging or containers for any such chemical substances. A digital image of the pharmaceutical in question 100 may be captured using a digital camera 210 that is electrically connected with an appliance, including in various embodiments a portable appliance 200 or an appliance not particularly adapted to be portable 250 (examples shown in FIGS. 2 and 3). A portable appliance 200 may comprise a cell phone, smart phone, personal digital assistant, laptop computer, electronic tablet, or any other portable electronic device connected with a digital camera 210. An appliance is also typically electrically connected with a screen 220 or other information output structure that facilitates communication of information to a user (not shown) of the appliance.

In the example shown in FIG. 1, portable appliance 200 may communicate wirelessly through a communications network 300 with a pharmaceutical identification server system 400. For example, in various embodiments, a user may cause the digital camera 210 of the portable appliance 200 to take a digital photograph, or to otherwise digitally record images of the pharmaceutical(s) in question 100. The user may then cause the portable appliance 200 to transmit the digital photograph information through a communications network 300 to a pharmaceutical identification server system 400. In various embodiments, a user may cause the portable appliance 200 to transmit the digital photograph by sending a text message, SMS message, MMS message, email, or any other suitable electrical information transmission. The communications network 300 may comprise a variety of computer systems, computer networks, the Internet, phone lines, satellite communications, wireless networks and the like. In certain embodiments where the portable appliance 200 comprises a suitable telephone, the user may transmit the photograph of the pharmaceutical(s) in question 100 to the pharmaceutical identification server system 400 by texting the photograph to a predetermined phone number. In those embodiments, the pharmaceutical identification server system 400 may receive the information texted to the predetermined number, and process that information according to the systems and methods described below. The foregoing describes example embodiments with optional features.

Pharmaceutical Identification Server Systems

Pharmaceutical identification server system 400 may comprise one or more computers and/or computer servers with memory, storage, processors, operating systems, programs, and interfaces for communicating with communications network 300. Pharmaceutical identification server system 400 may further comprise a plurality of identification systems for recognizing various characteristics of an image of a pharmaceutical and comparing those characteristics to characteristics of known pharmaceuticals stored in one or more databases. Such identification systems 400 and appliances 200, 250 (FIGS. 2, 3) may each variously include a photoelectric converter, a recognition processor, a memory, and an output unit. The photoelectric converter may convert the visible characteristics of a pharmaceutical into one or more voltage waveforms. The two-dimensional visible characteristics associated with the pharmaceutical in question may be converted into a one-dimensional signal, for example, by a scan method of a television set, which may be a time-series change of a voltage waveform. The memory may store one or more arithmetic control programs that control the recognition processor and data through which the recognized shape is presented in a specific format. In general, a recognition processor may process an unknown input through the photoelectric converter under the control of the program stored in the memory, and compare the processed image with standard patterns stored in the memory, so that an image of a known pharmaceutical whose image information patterns are most similar to the image information patterns of the pharmaceutical in question 100 can be recognized as a match, thus identifying the pharmaceutical in question 100. The output unit may send the recognized information to other information processors in a suitable manner. This is just one example among many suitable technologies that are known in the art.

Examples of known recognition systems that include elements that persons of skill in the art can adapt for use with the present system include: optical character readers (OCR) that can recognize both a printed character and a handwritten character; tablets that can recognize a handwritten character; optical mark readers (OMR) that can recognize special characters; bar code scanners; magnetic ink character readers (MICR); and facial recognition systems that can recognize complex shapes like faces, products and text in digital images, such as, for instance, the systems and methods disclosed in United States Patent Application Publication Number US 2011/0035406 A1 to Petrou et al., published Feb. 10, 2011, the entirety of which is incorporated herein by reference.

The various recognition algorithms may include techniques in which characters, logos, colors, and other identifying characteristics that appear in an area having a specific surface or shape such as a capsule or pill may be read and recognized by one or more recognition processors, and the characters, logos, colors, shapes, and other identifying characteristics are converted into code recognizable by digital electronic devices. Pharmaceuticals frequently include identifying combinations of letters and numbers imprinted on one or more sides of the pharmaceutical. In the example pharmaceutical identification server system 400 shown in FIGS. 1-3, the system 400 comprises an imprint identification system 410 that may be adapted to identify, isolate, and interpret imprints on the pharmaceutical in question 100, such as printed text or raised or recessed lettering in a variety of fonts, for instance by using a character recognition algorithm, as is known in the art. The imprint identification system 410 may be adapted to compare the imprints identified on the pharmaceutical in question 100 with known imprints used on known pharmaceuticals as recorded in a database 415 of previously identified and verified imprints. While a database 415 according to the present system would preferably include as many of the extant imprints as possible, following is a brief exemplary list of typical imprints: M357; AN 627; 512; WATSON 932; WATSON 853; M358; 2410 V; M360; M367; L484; WATSON 749; M 751; A 215; 5658 DAN; V 36 01; M363; WATSON 385; 54 142; TL 177; 93 833; M 05 52; WATSON 387; 5113 V; GG 225; WATSON 349; IP 110; 4212 V; IP 119.

Identifying logos also commonly appear on pharmaceuticals. The system 400 may thus comprise a logo identification system 420 that may be adapted to identify, isolate, and interpret logos on the pharmaceutical in question 100, such as trademarks, proprietary fonts, and the like, for instance by using an image recognition algorithm, as is known in the art. The logo identification system 420 may be adapted to compare the logos identified on the pharmaceutical in question 100 with known logos used on known pharmaceuticals as recorded in a database 425 of previously identified and verified logos. For example, unique logos exist for the following pharmaceutical brands: Abbott Laboratories; Actavis Elizabeth; Actavis Totowa; Advance Pharmaceutical; Andrx (Watson); Apotex; Barr; Boehringer Ingelheim; Caraco; Cephalon; Cobalt; Corepharma; Cypress; Dr Reddy's; Duramed; Endo; Eon (Sandoz); Ethex; Forrest; Genpharm; Glenmark; Global; Greenstone; Guardian Drug Company; Inwood Labs (Forrest); Ivax (Teva); Knoll; KVK Tech; LNK International; ESI Lederle Generics; Mallinckrodt; Mutual Pharmaceutical; Mylan; Par; Parke-Davis; PDK Labs; Purepac (Actavis US); Prasco; Qualitest; Ranbaxy; Roche; Roxane; Sandoz; Sanofi-Synthelabo; Savage; Schering; Shire US Inc.; Teva; Torrent Pharmaceuticals; Watson; Wellcome; West Ward; and Wyeth.

Pharmaceuticals are also manufactured in a wide variety of shapes. The system 400 may comprise a shape identification system 430 that may be adapted to identify, isolate, and interpret the shape of the pharmaceutical in question 100, such as round, oval, various capsule and tablet shapes and the like, for instance by using an image recognition algorithm, as is known in the art. The shape identification system 430 may be adapted to compare the shapes identified on the pharmaceutical in question 100 with known shapes used on known pharmaceuticals as recorded in a database 435 of previously identified and verified shapes. Identifying shapes of pharmaceuticals may include, for example: biconcave; biconvex; bowtie; capsule-shape; character-shape; diamond; d-shape; egg-shape; eight-sided; elliptical/oval; figure eight-shape; five-sided; four-sided; gear-shape; heart-shape; hourglass-shape; kidney-shape; oblong; oval; ovoid-rectangular; peanut; rectangle; round; seven-sided; shield-shape; six-sided; square; spherical; teardrop-shape; three-sided; and u-shape.

Colors may further identify pharmaceuticals. Accordingly, the system 400 may comprise a color identification system 440 that may be adapted to identify, isolate, and interpret the color(s) of the pharmaceutical in question 100, for instance by using a color recognition algorithm, as is known in the art. The color identification system 440 may be adapted to compare the colors identified on the pharmaceutical in question 100 with known colors used on known pharmaceuticals as recorded in a database 445 of previously identified and verified colors. Identifying colors of pharmaceuticals include, for example: beige; black; blue; brown; clear; gold; gray; green; maroon; orange; peach; pink; purple; red; tan; white; yellow; beige and red; black and green; black and teal; black and yellow; blue and brown; blue and gray; blue and orange; blue and peach; blue and pink; blue and white; blue and white specks; blue and yellow; brown and clear; brown and orange; brown and peach; brown and red; brown and white; brown and yellow; clear and green; dark and light green; gold and white; gray and peach; gray and pink; gray and red; gray and white; gray and yellow; green and orange; green and peach; green and pink; green and purple; green and turquoise; green and white; green and yellow; lavender and white; maroon and pink; orange and turquoise; orange and white; orange and yellow; peach and purple; peach and red; peach and white; pink and purple; pink and red specks; pink and turquoise; pink and white; pink and yellow; red and turquoise; red and white; red and yellow; tan and white; turquoise and white; turquoise and yellow; white and blue specks; white and red specks; white and yellow; yellow and gray; yellow and white.

Different or additional identification systems in lieu of or in addition to identification systems 410, 420, 430 and 440 may be used; those shown are merely examples.

Each identification system 410, 420, 430 and 440 may generate a positive identification signal (or absence of negative identification signal) when a sufficient match is found between the feature being identified on the pharmaceutical in question 100 and the corresponding feature on a known pharmaceutical. Each positive signal (or absence of a negative signal) may be transmitted to or inputted into a pharmaceutical identification algorithm 450. Based on a predetermined set of parameters, the pharmaceutical identification algorithm 450 may determine whether only one known pharmaceutical corresponds to the outputs of identification systems 410, 420, 430 and 440, i.e., whether there is a likely match between the pharmaceutical in question 100 and a single known pharmaceutical.

Where the pharmaceutical identification algorithm 450 determines that there is such a unique match to a known pharmaceutical, various information regarding that known pharmaceutical may be obtained from a pharmaceutical information database 460. That information may then be transmitted from the pharmaceutical identification server system 400 back to a user. For example, that information may be packaged as a text message, transmitted wirelessly from the identification server system 400, through a communications network 300, back to the portable appliance 200, and displayed on a screen 220 for the user to see. Thus, the user in that example can take a digital picture of a pharmaceutical in question 100 with a portable appliance 200 comprising a telephone, then text that picture to a predetermined telephone number, wait a short period of time for the pharmaceutical identification server system 400 to electronically recognize and identify the pharmaceutical in question 100, and then automatically receive a text message back from the server system 400 that includes an identification of the pharmaceutical in question 100, including predetermined and verified medical information regarding the matched pharmaceutical, such as, for example, its name, pictures of it (for the user to review of confirm the accuracy of the match), warnings, legal status (e.g., whether or not a prescription is required), as well as usage and interaction information. This is just one example of how to implement a system.

Where the pharmaceutical identification algorithm 450 determines that there is not a unique match to a known pharmaceutical, then that information may be transmitted from the pharmaceutical identification server system 400 back to a user. For example, the server system 400 may respond to the user, using any of the techniques mentioned herein, with an error message or a message stating that no match was found. Alternatively or additionally, the server system 400 may respond to the user with a message requesting that additional digital images be submitted, such as images of other sides of the pharmaceutical in question 100. Using a unique identifier communicated from the user's appliance 200, 250, the server system 400 may be adapted to combine subsequent submissions from the user with prior submissions from the same user, for instance within a limited time period from the first submission, and to perform the various identification analyses 410, 420, 430, 440 on the combined data from the user's multiple submissions.

Alternatively or additionally, where the pharmaceutical identification algorithm 450 determines that there are multiple matches to known pharmaceuticals, the server system 400 may respond to the user with a message listing the matches, and including, for example, pictures of the matching pharmaceuticals that may appear on the user's screen 220, so the user can compare the pictures to the pharmaceutical in question. If the user in such an embodiment then positively identifies which of the matching known pharmaceuticals corresponds to the pharmaceutical in question 100, the user may submit the picture of the correct known pharmaceutical back to the server system 400, and the server system 400, using the processes described above, should automatically respond to the user with complete information regarding that pharmaceutical.

The information in each of the databases 415, 425, 435, 445, 460, and any other databases, may be centrally controlled or otherwise securely maintained to preserve the integrity of the system and the accuracy of the results it produces. All of the foregoing describes example embodiments with optional features.

### Example 2

FIG. 2 shows another example embodiment of a pharmaceutical recognition and identification system. This embodiment may be similar to any of the embodiments discussed with regard to FIG. 1, except that the appliance 250 may be fixed, i.e., not particularly adapted to be portable. An appliance 250 in these embodiments may include various components that are separate or part of the same structure, such as a computer or digital data processing device 255 electrically coupled with a digital camera 210, a wireless communication mechanism, and a screen or other information output device 220. Such a fixed system may be useful as an installation in a pharmacy or other pharmaceutical dispensary. The camera 210 in such a system may be manually operated by a user or it may be automatically triggered to take digital photographs of pharmaceuticals in question 100 as they are being dispensed, and the appliance 250 may be adapted to automatically transmit the digital photograph(s) to the pharmaceutical identification server system 400 for processing as discussed above.

Once the server system 400 responds to the appliance 250 (or to any other appropriate appliance, such as a pharmaceutical dispensing system, not shown) with match information, the appliance 250 may communicate with a dispensing system computer (not shown) that is involved in ordering, billing for, managing, tracking or otherwise dispensing the pharmaceuticals in question 100. If the identity of the pharmaceutical in question 100 provided by the server system 400 does not match the identity of the pharmaceutical in question 100 as recorded in the dispensing computer, then the system may be adapted to institute any number of protective measures, including setting off an alarm, stopping the dispensing, and preventing check-out or billing of the order until, for instance, a pharmacist manually inspects the pharmaceuticals in question 100, compares them to the prescription for the pharmaceuticals, resolves any discrepancies, and then clears the error from the system. Once again, all of the foregoing describes example embodiments with optional features.

### Example 3

FIG. 3 depicts an additional example embodiment of a pharmaceutical recognition and identification system. This embodiment may be similar to any of the embodiments discussed with regard to FIGS. 1 and 2, except that the appliance 260 includes a computer or digital data processing device 265 that is not directly coupled with a wireless communication mechanism, but rather communicates with the pharmaceutical identification server system 400 via a wired connection. It is acknowledged that such wired connections may nonetheless include one or more wireless transmissions between the source and destination of any electronic communication. However, in certain embodiments the fixed appliance 260 is directly connected to, or even incorporates within it, pharmaceutical identification server system 400, such that the system is self-contained in fixed appliance 260. Likewise, a portable appliances 200, 250, as shown in FIGS. 1 and 2, could be directly connected to, or could even incorporate within them, pharmaceutical identification server system 400. The foregoing describes example embodiments with optional features.

Method of Use

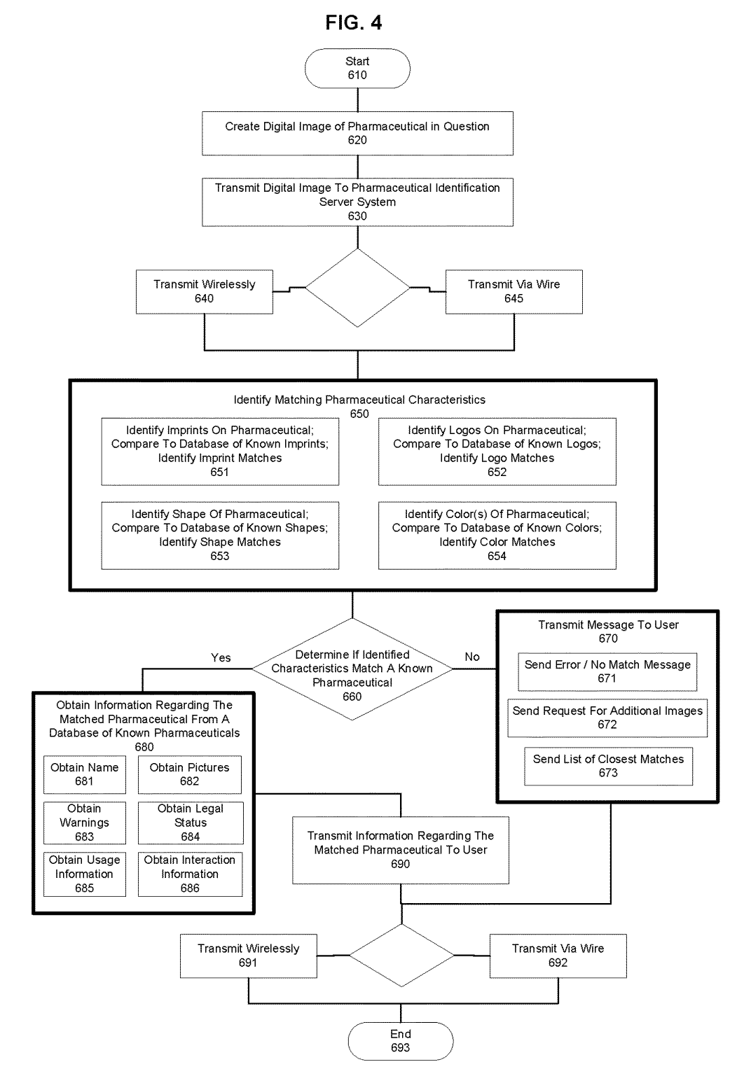

FIG. 4 depicts various optional steps for carrying out the method of using the system described herein. An example method starts 610 with a user creating 620 a digital image of a pharmaceutical in question 100. A user could be a person, or a machine operating passively, as described above with regard to dispensing. The digital image may transmitted 630, wirelessly 640, or by wire 645, to a pharmaceutical identification server system 400. The pharmaceutical identification server system 400 identifies 650, characteristics that sufficiently match between the pharmaceutical in question 100 and known pharmaceuticals. Steps that may be included in the identifying match step 650 include:

step 651: identifying imprints on the pharmaceutical in question 100, comparing them with a database of known imprints, and identifying imprint matches;

step 652: identifying logos on the pharmaceutical in question 100, comparing them with a database of known logos, and identifying logo matches;

step 653: identifying shapes of the pharmaceutical in question 100, comparing them with a database of known shapes, and identifying shape matches; and

step 654: identifying colors of the pharmaceutical in question 100, comparing them with a database of known colors, and identifying color matches.

Additional or different steps, characteristics, and databases may be used.

Based on a predetermined set of parameters, a pharmaceutical identification algorithm 450 may determine 660 whether only one known pharmaceutical sufficiently corresponds to the outputs of identifying match steps 651, 652, 653, 654, et seq.; i.e., whether there is a sufficiently definite match between the pharmaceutical in question 100 and a single known pharmaceutical.

Where the pharmaceutical identification algorithm 450 determines 660 that there is such a unique match to a known pharmaceutical, various medical information regarding that known pharmaceutical may be obtained 680 from a pharmaceutical information database 460. Steps that may be included in the obtaining step 680 include:

step 681: obtaining the name of the known pharmaceutical;

step 682: obtaining pictures of the known pharmaceutical;

step 683: obtaining warnings regarding the known pharmaceutical;

step 684: obtaining the legal status of the known pharmaceutical, for instance, whether or not a prescription is required;

step 685: obtaining usage information for the known pharmaceutical; and

step 686: obtaining interaction information regarding the known pharmaceutical.

Additional or different steps, information, and databases may be used. For example, any other suitable information regarding the known pharmaceutical, such as its chemical composition, history, indications, contra-indications, generic or name-brand equivalents, manufacturer, and the like, may be obtained in obtaining step 680. The obtained information may then be transmitted 690, wirelessly 691 or by wire 692, from the pharmaceutical identification server system 400 back to a user, as previously described.

Where the pharmaceutical identification algorithm 450 determines 660 that there is not a unique match to a known pharmaceutical, then that or related information may be transmitted 670 from the pharmaceutical identification server system 400 back to a user. Steps that may be included in the transmitting step 670 include:

step 671: sending an error/no-match message to the user;

step 672: sending a request to the user seeking additional images of the pharmaceutical in question 100;

step 673: sending a list to the user of the matches, including, for example, pictures of the matching pharmaceuticals that may appear on the user's screen 220, so the user can compare the pictures to the pharmaceutical in question 100. The user may then submit the picture of the correct known pharmaceutical back to the server system 400, and it should automatically respond to the user with complete information regarding that pharmaceutical, applying the steps described above.

These are just examples. Any other or different appropriate message or information may be transmitted 670 to the user. The transmitting step 670 may be accomplished wirelessly 691 or by wire 692, after which the process may end 693.

The above steps are set forth to illustrate general concepts. Numerous other steps, and combinations and permutations thereof, are contemplated, and are inherently and necessarily disclosed to persons of ordinary skill in the art by the description of the system herein.

Although exemplary embodiments and applications of the invention have been described herein, there is no intention that the invention be limited to these exemplary embodiments and applications or to the manner in which the exemplary embodiments and applications operate or are described herein. Indeed, many variations and modifications to the exemplary embodiments are possible as long as the resulting system or method falls within the scope of one of the following claims or its equivalent.

What is claimed is:

1) An electronic pharmaceutical recognition and identification system for identifying and providing information regarding an unidentified pharmaceutical, comprising:
an electronic appliance comprising a digital camera and a screen and adapted to electronically communicate digital information to and from a pharmaceutical identification server system;
a pharmaceutical identification server system adapted to electronically communicate digital information to and from the electronic appliance, the pharmaceutical identification server system comprising a processor, memory, a program, and one or more identification systems adapted to identify one or more characteristics of a digital image of an unidentified pharmaceutical and further adapted to compare the identified characteristics with one or more databases of corresponding characteristics of known pharmaceuticals and further adapted to identify matches between the identified characteristics of the unidentified pharmaceutical and the corresponding characteristics of the known pharmaceuticals and further adapted to obtain from a database and transmit to the electronic appliance information regarding a known pharmaceutical when a predetermined number of the identification systems indicate that the identified characteristics of the unidentified pharmaceutical sufficiently match the corresponding characteristics of the known pharmaceutical.

2) The electronic pharmaceutical recognition and identification system of claim 1, wherein the electronic appliance is adapted to be portable.

3) The electronic pharmaceutical recognition and identification system of claim 1, wherein the electronic appliance is adapted to electronically communicate digital information to and from the pharmaceutical identification server system wirelessly.

4) The electronic pharmaceutical recognition and identification system of claim 1, wherein the electronic appliance and the pharmaceutical identification server system are adapted to electronically communicate digital information to and from each other through a communications network.

5) The electronic pharmaceutical recognition and identification system of claim 1, wherein the electronic appliance is adapted to electronically communicate digital information to and from the pharmaceutical identification server system using text messaging.

6) The electronic pharmaceutical recognition and identification system of claim 1, wherein the characteristics comprises one or more imprints.

7) The electronic pharmaceutical recognition and identification system of claim 1, wherein the characteristics comprises one or more logos.

8) The electronic pharmaceutical recognition and identification system of claim 1, wherein the characteristics comprises one or more shapes.

9) The electronic pharmaceutical recognition and identification system of claim 1, wherein the characteristics comprises one or more colors.

10) The electronic pharmaceutical recognition and identification system of claim 1, wherein the information regarding the known pharmaceutical comprises the name of the known pharmaceutical.

11) The electronic pharmaceutical recognition and identification system of claim 1, wherein the information regarding the known pharmaceutical comprises a digital image of the known pharmaceutical.

12) The electronic pharmaceutical recognition and identification system of claim 1, wherein the information regarding the known pharmaceutical comprises medical information regarding the known pharmaceutical.

13) The electronic pharmaceutical recognition and identification system of claim 1, wherein the electronic appliance is electrically connected directly to the pharmaceutical identification server system.

14) The electronic pharmaceutical recognition and identification system of claim 1, wherein the electronic appliance comprises the pharmaceutical identification server system.

15) A method of recognizing and identifying an unidentified pharmaceutical and providing information regarding the unidentified pharmaceutical, comprising:
providing an electronic appliance comprising a digital camera and a screen and adapted to electronically communicate digital information to and from a pharmaceutical identification server system;
providing a pharmaceutical identification server system adapted to electronically communicate digital information to and from the electronic appliance, the pharmaceutical identification server system comprising a processor, memory, a program, and one or more identification systems adapted to identify one or more characteristics of a digital image of an unidentified pharmaceutical and further adapted to compare the identified characteristics with one or more databases of corresponding characteristics of known pharmaceuticals and further adapted to identify matches between the identified characteristics of the unidentified pharmaceutical and the corresponding characteristics of the known pharmaceuticals and further adapted to obtain from a database and transmit to the electronic appliance information regarding a known pharmaceutical when a predetermined number of the identification systems indicate that the identified characteristics of the unidentified pharmaceutical sufficiently match the corresponding characteristics of the known pharmaceutical;
taking at least one digital picture of the unidentified pharmaceutical with the digital camera;
transmitting the at least one digital picture from the electronic appliance to the pharmaceutical identification server system; and
receiving at the electronic appliance information regarding a known pharmaceutical that has a predetermined number of characteristics that sufficiently match the corresponding characteristics of the unidentified pharmaceutical.

16) The method of claim 15, wherein either the step of transmitting the at least one digital picture from the electronic appliance to the pharmaceutical identification server system, or the step of receiving at the electronic appliance information regarding a known pharmaceutical, or both, are accomplished by text messaging.

17) The method of claim 15, wherein the information regarding the known pharmaceutical that is received at the electronic appliance comprises the name of the known pharmaceutical.

18) The method of claim 15, wherein the information regarding the known pharmaceutical that is received at the electronic appliance comprises a digital image of the known pharmaceutical.

19) The method of claim 15, wherein the information regarding the known pharmaceutical that is received at the electronic appliance comprises medical information regarding the known pharmaceutical.

20) An electronic pharmaceutical recognition and identification system for identifying and providing information regarding a dispensed pharmaceutical, comprising:
an electronic appliance comprising a digital camera, a processor, memory, a program, and adapted to electronically communicate digital information to and from a pharmaceutical identification server system, or to and from a pharmaceutical dispenser system, or both;
a pharmaceutical identification server system adapted to electronically communicate digital information to and from the electronic appliance, or to and from a pharmaceutical dispenser system, or both, the pharmaceutical identification server system comprising a processor, memory, a program, and one or more identification systems adapted to identify one or more characteristics of a digital image of a dispensed pharmaceutical and further adapted to compare the identified characteristics with one or more databases of corresponding characteristics of known pharmaceuticals and further adapted to identify matches between the identified characteristics of the dispensed pharmaceutical and the corresponding characteristics of the known pharmaceuticals and further adapted to obtain from a database and transmit to the electronic appliance or to a pharmaceutical dispenser system, or both, information regarding a known pharmaceutical when a predetermined number of the identification systems indicate that the identified characteristics of the dispensed pharmaceutical sufficiently match the corresponding characteristics of the known pharmaceutical; and
a pharmaceutical dispenser system comprising a pharmaceutical dispensing mechanism, a processor, memory, and a program, the pharmaceutical dispenser system adapted to dispense the dispensed pharmaceutical upon entry of an order for an ordered pharmaceutical, the pharmaceutical dispenser in electronic communication with the electronic appliance or the pharmaceutical identification server system, or both, the pharmaceutical dispenser system further adapted to inhibit the dispensing or sale of the dispensed pharmaceutical when the pharmaceutical dispenser system receives information from the electronic appliance or the pharmaceutical identification server system, or both, indicating that a known pharmaceutical having characteristics that sufficiently match characteristics of the dispensed pharmaceutical is a different pharmaceutical than the ordered pharmaceutical.
